(19) United States
(12) Patent Application Publication
(10) Pub. No.: US 2008/0275757 A1
(43) Pub. Date: Nov. 6, 2008

(54) Metric Conversion for Online Advertising

(75) Inventors: Abhinay Sharma, Mountain View, CA (US); Kai Chen, Santa Clara, CA (US); Rob Kniaz, San Francisco, CA (US); Joerg Heilig, Los Altos, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/025,642

(22) Filed: Feb. 4, 2008

Related U.S. Application Data
(60) Provisional application No. 60/916,260, filed on May 4, 2007.

(51) Int. Cl. G06Q 30/00

(52) U.S. Cl. 705/10; 705/14

(57) ABSTRACT

Methods, systems and computer program products for estimating a CPC bid (eCPC) as a function of a target CPA bid based on predictive data (e.g., predicted conversion rate) have been described. The eCPC parameter can be used to develop a model that could be used to charge advertisers on a CPA basis while crediting publishers on a CPC basis.

### RELATED APPLICATION

This application claims the benefit of priority under 35 U.S.C. § 119 of U.S. Provisional Application No. 60/916,260, titled “Metric Conversion For Online Advertising,” filed May 4, 2007, which is incorporated herein by reference in its entirety.

### TECHNICAL FIELD

The subject matter of this application is generally related to online advertising.

### BACKGROUND

Interactive media (e.g., the Internet) has great potential for improving the targeting of advertisements (“ads”) to receptive audiences. For example, some websites provide information search functionality that is based on keywords entered by the user seeking information. This user query can be an indicator of the type of information of interest to the user. By comparing the user query to a list of keywords specified by an advertiser, it is possible to provide targeted ads to the user.

Another form of online advertising is ad syndication, which allows advertisers to extend their marketing reach by distributing ads to additional partners. For example, third party online publishers can place an advertiser's text or image ads on web properties with desirable content to drive online customers to the advertiser's website.

In some online advertising systems, advertisers pay on a Cost-Per-Impression (CPM) basis (e.g., cost-per-thousand impressions) to increase visibility and build brand awareness of their ads. The advertiser may pay a set rate each time an ad is shown to a consumer. CPM prices are typically negotiated for individual ads or ad campaigns with each publisher, for example, by a publisher's sales force or by the price of the product being advertised.

Advertisers who are concerned with the low number of conversions generated from ads may pay for their ads on a Cost-Per-Click (CPC) basis. In a Cost-per-Click (CPC) system, advertisers may pay a set rate each time the consumer clicks on an ad. CPC systems are often associated with bidding markets, in which an advertiser bids against other advertisers for the cost of a click. Most CPC ad revenue today comes from keyword bidding, in which advertisers bid for clicks from ads attached to particular keywords.

In other online advertising systems, advertisers may pay for their ads based on a performance driven Cost-Per-Action (CPA) model in which the advertisers are charged solely on qualifying actions, such as a sale or registration, in contrast to the marketing costs associated with reaching that sale or registration.

From an advertiser's perspective, CPA advertising is sometimes desirable over CPC advertising because CPA advertising may have lower business risk and less invalid clicks. For example, CPA pricing structure does not debit advertisers for clicks that do not convert into a transaction of a particular kind, and may not be as susceptible to “click fraud” that centers around CPC advertising. The CPA pricing structure is also desirable over the CPM pricing structure as it is often more difficult to accurately price CPM ads to reflect the true values of the ads to the advertisers. CPM-priced ads also require constant monitoring by the advertisers in order to determine the business effectiveness of these ads (e.g., by tracking rates of clicks, number of click-throughs and conversions of clicks to purchases and/or actions). Such monitoring is less necessary in CPA advertising.

Unlike the advertisers, publishers prefer to be compensated based on CPC and/or CPM pricing structure so as to generate revenue regardless of the number of conversions. As a result, publishers have few business incentives to participate in CPA advertising, limiting the number of publishers for advertising CPA ads.

### SUMMARY

An advertiser specifies a target bid (e.g., CPA target bid or other target) for a conversion event associated with an ad. A predicted conversion rate or value is determined (e.g., empirically) for potential impressions of the ad based on conversion data (e.g., historical conversion data) for the ad and impression context data (e.g., current impression context data). The predicted conversion rate and target bid can be used to estimate a click-based bid. Publishers can be compensated based on the estimated click-based bid, while advertisers can be debited using the target bid originally specified.

In some implementations, a correction factor may be computed to better predict the conversion rate. For example, the correction factor may be computed using an iterative process (e.g., by a learning model) that compensates for the deviation error of the predicted conversion rate within a bidding period. The iterative process may employ historical performance data to obtain an accurate estimated click-based bid. The correction factor may be automatically adjusted in an adaptive way to mitigate changes or fluctuations of the predicted conversion rate so as to yield an accurate estimated click-based bid as a function of the target bid.

In some implementations, the correction factor may be updated multiple times over a single bidding period, or updated over multiple periods. This feedback strategy can reduce any deviation between the predicted conversion rate and actual conversion rate.

In some implementations, a method includes: obtaining input specifying a first metric value associated with an advertisement; determining a predicted conversion rate for a potential impression of the advertisement; estimating a second metric value based on the first metric value and the predicted conversion rate; compensating based on the second metric value; and debiting based on the first metric value. The first metric value may be a value based on a Cost-Per-Action model, and the second metric value may be based on a Cost-Per-Click model. Alternatively, the first metric value may be a value based on one of Cost-Per-Click model or Cost-Per-Action model, and the second metric value may be based on a Cost-Per-Impression model.

In another implementation, a system includes a processor and a computer-readable medium operatively coupled to the processor. The computer-readable medium includes instructions, which, when executed by the processor, causes the processor to perform operations including: obtaining input specifying a first metric value associated with an advertisement; determining a predicted conversion rate for a potential impression of the advertisement; estimating a second metric value based on the first metric value and the predicted conversion rate; compensating based on the second metric value; and debiting based on the first metric value.

Other implementations of metric conversion for online advertising are disclosed, including implementations directed to systems, methods, apparatuses, computer-readable mediums and user interfaces.

### DESCRIPTION OF DRAWINGS

FIG. 1 is a block diagram showing an example of an online advertising system.

FIG. 2 is a block diagram showing an example of an advertising management system.

FIG. 3 is a flow diagram showing an example of a metric conversion process.

FIG. 4 is a flow diagram showing an example of a metric conversion process using a correction factor.

FIG. 5 is a block diagram showing an example of an architecture for the advertisement management system shown in FIG. 4, which can be configured to implement the processes shown in FIGS. 3 and 4.

### DETAILED DESCRIPTION

### Advertising System Overview

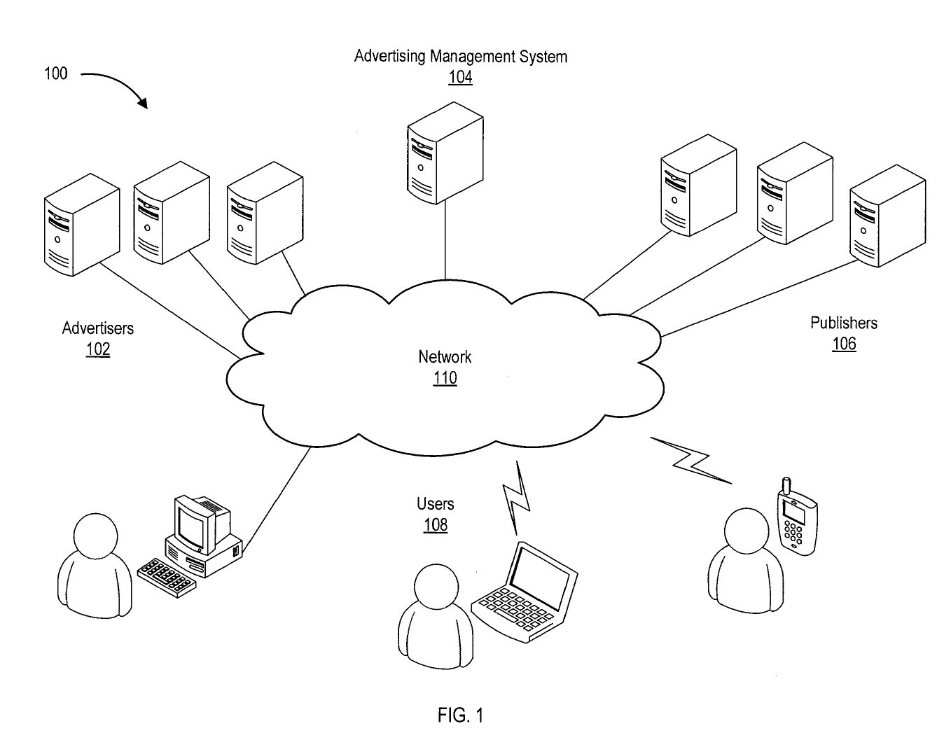

FIG. 1 is a block diagram showing an example of an online advertising system 100. In some implementations, one or more advertisers 102 can directly, or indirectly, enter, maintain, and track advertisement (“ad”) information in an advertising management system 104. The ads may be in the form of graphical ads, such as banner ads, text only ads, image ads, audio ads, video ads, ads combining one of more of any of such components, etc. The ads may also include embedded information, such as a link, meta-information, and/or machine executable instructions. One or more publishers 106 may submit requests for ads to the advertising management system 104. The advertising management system 104 responds by, for example, sending computer program codes (e.g., JavaScript) to the publishers 106, which can be executed by the publishers and rendered as ads on publishers' web properties (e.g., websites and other network-distributed content).

Other entities, such as users 108 and the advertisers 102, can provide usage information to the advertising management system 104, such as, for example, whether or not a conversion or click-through related to an ad has occurred. This usage information can include measured or observed user behavior related to ads that have been served. The advertising management system 104 performs financial transactions, such as crediting the publishers 106 and charging the advertisers 102 based on the usage information.

A computer network 110, such as a local area network (LAN), wide area network (WAN), the Internet, or a combination thereof, connects the advertisers 102, the system 104, the publishers 106, and the users 108. The network 110 can facilitate wireless or landline communication between each entity. The network 110 may be all or a portion of an enterprise or secured network. While illustrated as single network, the network 110 may be a continuous network logically divided into various sub-nets or virtual networks without departing from the scope of this disclosure, so long as at least a portion of the network 110 may facilitate communications of ads between the advertising system manager 104, the advertisers 102, the publisher 106 and the users 108.

In some implementations, the network 110 encompasses any internal or external network, networks, sub-network, or combination thereof operable to facilitate communications between various computing components in system 100. The network 110 may communicate, for example, Internet Protocol (IP) packets, Frame Relay frames, Asynchronous Transfer Mode (ATM) cells, voice, video, data, and other suitable information between network addresses. The network 110 may include one or more local area networks (LANs), radio access networks (RANs), metropolitan area networks (MANs), wide area networks (WANs), all or a portion of the global computer network known as the Internet, and/or any other communication system or systems at one or more locations.

### Ad Management System Overview

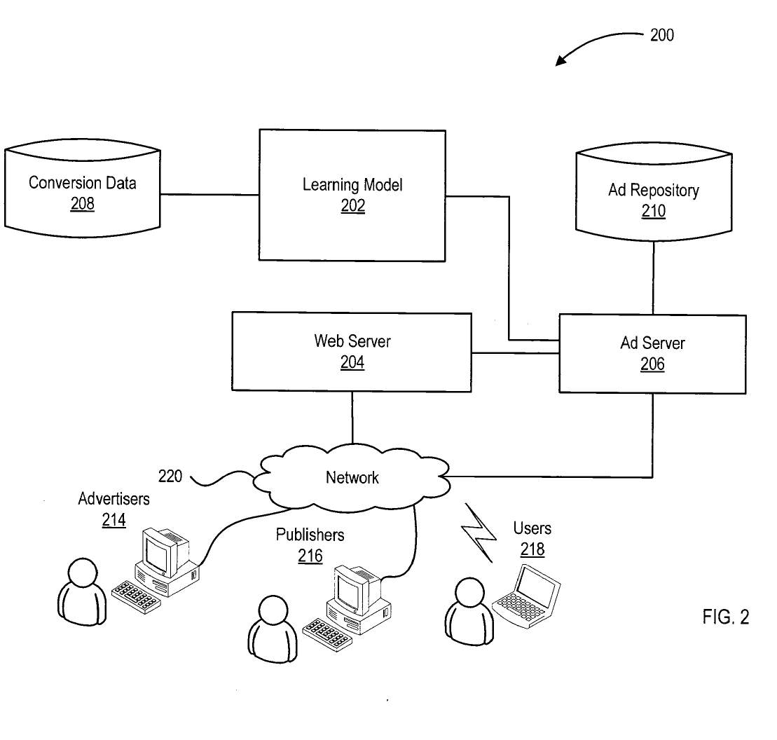

FIG. 2 is a block diagram of an implementation of an ad management system 200 for implementing metric conversion. In some implementations, the system 200 generally includes a learning model 202, a web server 204, and an ad server 206. The system 200 is operable to communicate with advertisers 214, publishers 216, and users 218, over one or more networks 220 (e.g., the Internet, intranet, Ethernet, wireless network).

In some implementations, a publisher 216 can request an ad from the ad server 206. In response to the request, one or more ads (e.g., image ads) are sent to the publisher 216. The ad(s) can be placed on, for example, a web property owned or operated by the publisher 216 (e.g., a web site). In some implementations, the web page can have a page content identifier (ID), which can be used by the ad server 206 to determine ad context for targeting ads. These implementations target ads in the hope that the users, e.g., user 218, will be more receptive to targeted ads than to untargeted ads.

In some implementations, when the user 218 clicks an ad served by the ad server 206, the user 218 is directed to a landing page on the web property (e.g., a web site) of the advertiser 214. The user 218 may then perform a conversion event at the website (e.g., make a purchase, register). The conversion event generates conversion data which is sent to the system 200 and stored in a repository (e.g., MySQL® database). In this manner, a conversion history can be accumulated and maintained for each ad or ad group in an advertiser's ad campaign.

In some implementations, the advertiser 214 can access the system 200 through the network 220 and the web server 204 using, for example, a web browser (e.g., Microsoft™ Internet Explorer, Mozilla™, Firefox™, or the like). The web server 204 serves the advertiser 214 one or more web pages presenting a user interface for allowing the advertiser 214 to manage ad campaigns.

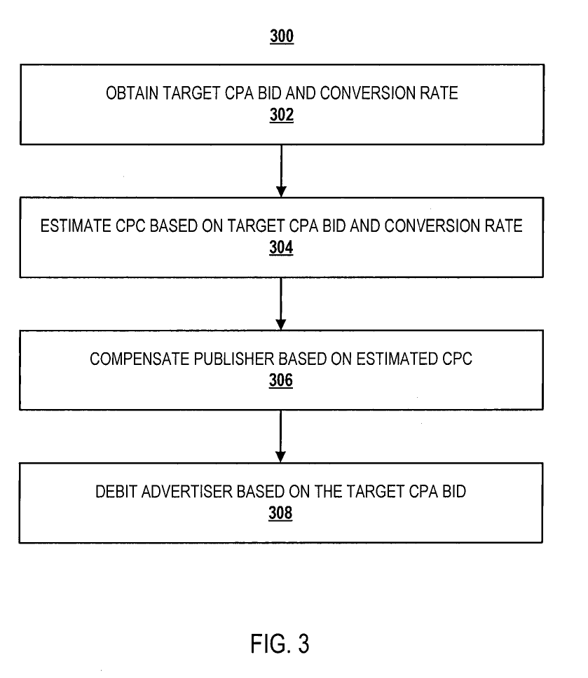

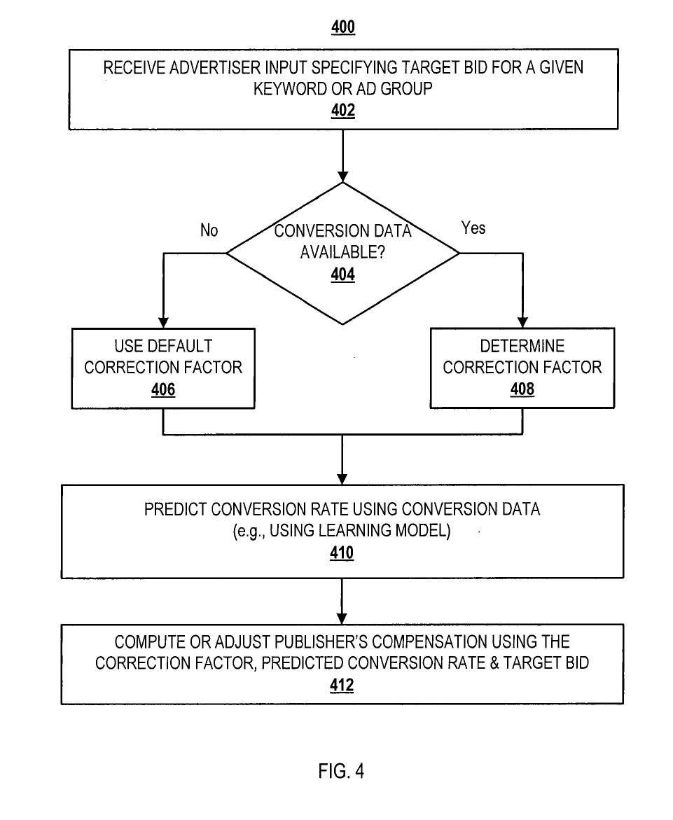

The learning model 202, which can be coupled to the ad server 206 and the conversion data repository 208, may include a statistical and probability model constructed using statistical techniques. Such techniques may include, for example, logistic regression, regression trees, boosted stumps, or any other statistical modeling techniques. In some implementations, the learning model 202 provides a predicted conversion rate (“pCVR”), which can be used to perform a metric conversion, as described below with reference to FIGS. 3 and 4.

In some implementations, the conversion data repository 208 may include one or more logical or physical memory devices configured to store a large data set (e.g., millions of instances and hundreds of thousands of features) that may be used, for example, to create and train the learning model 202. The data may include conversion data, advertisement information, such as advertisement data, user information, and document or content information, that may be used to create a model that may be used to determine a metric conversion rate. The advertisement data may include data relating to ads previously provided to users 218 and whether the ads were selected or not selected by the users 218. The user information may include Internet Protocol (IP) addresses, cookie information, languages, and/or geographical information associated with the users. The document information may include information relating to the documents accessed by the users 218, such as the Uniform Resource Locators (URLs) associated with these documents. In other exemplary implementations, other types of data may alternatively or additionally be stored by the data repository.

In some implementations, the learning model 202 can include an ad ranking model. The ad ranking model may predict whether a user will select a particular ad when accessing a document. A document may include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad slots in the document may be defined by embedded information or instructions. In the context of the Internet, a common document is a web page. Web pages often include content and may include embedded information (such as meta information, hyperlinks, etc.) and/or embedded instructions (such as JavaScript®, etc.). In many cases, a document has a unique, addressable, storage location and can therefore be uniquely identified by this addressable location.

The ad ranking model may be used as part of a function to determine what ads to provide to users 218 when the users are accessing the documents. To facilitate data generation for use by the ad ranking model, information concerning a user and documents accessed by the user can be collected. As discussed above, information concerning a user may include IP address, cookie information, languages, geographical information and document information may include information relating to the documents accessed by the user (e.g., a URL of a web site visited by the user). Ads stored in the ad repository 210 may then be ranked based, at least in part, on the data stored by the learning model 202. The rank of an ad may, in some cases, correspond to the probability that a user will select the ad when accessing a particular document. Each ad can then be served to the user based on a respective rank. For example, the top one or more ads may be served to the users 218. Alternatively, ads that have ranks above a predetermined threshold may be served to the users 218.

The position of the ads within a document accessed by the users 218 also may be based, at least in part, on the ranks of the ads. For example, higher ranking ads may be positioned at more prominent or visually-recognized locations then lower ranking ads. Ads presented to the user, whether the user selected or did not select the ad(s), and the document(s) that the user accessed when presented with the ad(s) may be forwarded to the ad ranking model to create an empirical model so as to improve ad ranking.

### Ad Campaign, Ad Slot and Ad Placement Bidding

Referring back to FIG. 1, each advertiser 102 may establish an advertising program with the advertising management system 104. An advertising program may include, for example, ad campaigns, creatives, targeting and the like. The advertiser 102 may define an “ad campaign” which can include one or more ad groups each including one or more ads. An ad group may define, for example, a product type (e.g., Hats or Pants), and a creative may include an ad textually or graphically defining the product type Each ad group or ad may include a start date, an end date, budget information, geographical targeting information, and syndication information.

Each ad or ad group may include individual price information (e.g., cost, average cost, or maximum cost (per impression, per selection, per conversion, etc.)). For example, the advertiser 102 may specify a maximum monetary value with the advertising management system 104 as to how much the advertiser 102 is willing to pay per user click, impression or conversion per ad or ad group. The maximum monetary value may be based on the number of impressions (e.g., CPM bidding), the number of clicks on an ad (e.g., CPC bidding), or the number of conversions (e.g., CPA bidding) generated in response to an ad. For example, if the advertiser 102 has selected a CPC bidding model, the advertiser 102 can enter a maximum CPC bid which represents the highest amount the advertiser 102 is willing to pay if an ad associated with an ad group receives a click. As another example, if the advertiser 102 has selected a CPA bidding model, the advertiser 102 can enter a maximum CPA bid which represents the highest amount an advertiser is willing to pay if an ad associated with that ad group generates a conversion. Based on the defined bidding model, the publishers 106 can be credited and the advertisers 102 can be debited accordingly.

When an ad request is received, an ad that corresponds to the received ad request is identified. If more than one ad has been identified, an auction can be conducted to identify which ad to be served. During the auction, the ads may be ranked in accordance with one or more associated ad campaign parameters. The one or more ad campaign parameters may include, without limitation, default bids (e.g., CPC, CPA or CPM bids), daily budget defined by the advertisers 102 (e.g., at the time of registering an ad campaign), and relevance of an ad that can be determined by various methods, such as by inferring a high relevance for an ad with respect to, for example, a particular keyword query.

The advertisers 102 may, prior to an auction or at the time of registering an ad campaign, define ad campaign parameters or auction factors used for ranking ads. For example, an advertiser can enter a maximum CPM, CPC or CPA bid for each ad group. The advertisers 102 also can use a combination of maximum CPM, CPC and CPA bids within an ad group. For example, an advertiser can submit a maximum CPC bid for keyword-targeted placements and a maximum CPM bid for site-targeted placements.

In some implementations, the defined ad campaign parameters or auction factors are ranked. For example, the advertising management system 104 may select and rank the advertisers' default bids from highest to lowest. As another example, auction factors such as clickthrough rates (CTRs) and conversion rates (CVRs) can be ranked from largest to smallest.

Clickthrough rate (CTR) is one measure used to determine advertisement quality or effectiveness of an ad. CTR represents the fraction of times a given ad gets “clicked” on when a given advertisement creative is presented to the users. Clicking through an ad can activate a function, such as redirecting a browser to a landing page or a web page provided by an advertiser. CTR of an ad can be determined to identify how frequently the ad is accessed when it is presented. The CTR of an ad can be calculated by dividing the number of clickthroughs associated with the ad by the number of impressions of that ad over a given time period.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase before leaving that web page. Alternatively, a conversion may be defined as a user being shown an ad, and making a purchase on the advertiser's web page within a predetermined time (e.g., seven days). Many other definitions of what constitutes a conversion are possible. For example, a conversion also may include signing up to be a member of a web site, filling out an online form, making a purchase upon contacting an advertiser via online creatives and the like.

In general, the ratio of the number of conversions to the number of clicks of an ad is commonly referred to as the conversion rate. In some implementations, conversion rate can be defined as:

$$Conversion Rate = \frac{\# Of Sales From A Given Ad}{\begin{matrix}\# Of Clicks To Advertiser ' s \\ Web Property From The Ad\end{matrix}} \qquad [ 1 ]$$

An ad campaign parameter or auction factor also can be weighted to increase or decrease the impact that auction factor has on ad ranking. For example, an ad that has a higher CTR can be ranked above an ad that has a lower CTR, even if the ad with the lower CTR has an equal or greater default bid.

The weight between various auction factors may be adjusted as desired, and other factors also may be included, in producing a weighted score for ranking each ad. Based on the ranking (and any adjustment thereof as a result of the weighted scores) determined during the auction, the identified ads can be selected for presentation. For example, if the identified ads are to be presented in a web page that has four ad slots each slot displaying one ad, the four highest ranked ads can be selected for presentation. Further, the ranking established during the auction can be used to determine a display order. For example, the highest ranked ad can be assigned to the most prominent display position.

As an example, assuming that there are three advertisers in an auction bidding for an ad placement in an ad slot where advertiser “A” has a maximum CPC bid of $0.75 for a text ad, advertiser “B” has a maximum CPC bid of $0.50 for a text ad, and advertiser “C” has a maximum CPC bid of $1.00 for a text ad, then the winner of the auction can be determined by converting the maximum CPC bids to an estimated CPM (“eCPM”) level and comparing the results to CPM bids. A maximum CPC bid may be converted to an eCPM by aggregating the CPC bid with a predicted clickthrough rate (pCTR) multiplied by 1000, as can be generally given by [2]:

eCPM_{CPC}=1000*pCTR*CPC_{BID} [2]

The product of the CPC bid is multiplied by a factor of 1000 so as to normalize the product of the CPC bid and the pCTR to a cost value per one thousand impressions. In some implementations, the pCTR may be derived by the learning model 202 using historical data (e.g., clickthrough data).

In implementations in which any of the advertisers (advertiser “A”, advertiser “B” and advertiser “C”) defines a maximum CPM bid instead of a maximum CPC bid, then the eCPM is the same as the CPM bid, as can be generally given by [3]:

eCPM_{CPM}=CPM_{BID} [3]

Equation [3] provides that the estimated CPM is equivalent to the CPM bid specified by the advertisers. For example, if an advertiser specifies a CPM bid of $5 per thousand impressions, then the eCPM is also $5.

The advertising management system 104 may, in some implementations, provide a recommended CPA bid to the advertisers 102. The advertisers 102 may use the recommended CPA bid as a target CPA bid for each of the advertiser's ad groups instead of a maximum CPC bid or a maximum CPM bid. Generally, advertisers prefer the selection of a target CPA bid over maximum CPC bid and maximum CPM bid because the CPA pricing model only debits the advertisers for clickthroughs that convert.

To compute the eCPM as a function of a target CPA bid, it should be understood that the target CPA bid may be defined as a function of a current CPC bid and a conversion rate. As an example, if an advertiser currently has a maximum CPC bid of $0.30 and a conversion rate of 5% of clickthroughs, the target CPA bid would be $6.00 ($6.00=$0.30/5%). In practice the advertiser's maximum CPC bids will typically vary from ad to ad and from keyword to keyword for a single ad. In such cases, the target CPA bid can be computed using the following formula:

$$CPA = \frac{{\sum }_{i = 1}^{N} Max {CPCbid}_{i}}{{\sum }_{i = 1}^{M} {Conversions}_{i}} , \qquad [ 4 ]$$

where the numerator of [4] is the sum of “N” maximum CPC bids over all the clicks that an advertiser received during a relevant period of time (e.g., over the past month), and the denominator of [4] is the total number of “M” conversions that resulted from these clicks. While implementations above refer to maximum CPC bids, other CPC bids such as target CPC bids, average CPC bids and minimum CPCs also are contemplated.

The advertisers 214 may, in some implementations, specify both a default click-based bid (e.g., maximum CPC) and a target bid (e.g., target CPA bid) for each keyword or ad group in an ad campaign. The default maximum CPC bid can be used to predict a conversion rate for an ad or ad group when conversion data 208 is not available or is insufficient to do so (e.g., due to a new ad or ad group). For example, a conversion rate can be estimated by dividing a default maximum CPC bid by a target CPA bid. Alternatively, the default maximum CPC bid can be used as default instead of predicting a conversion rate when there is insufficient information to do so.

In some implementations, the target bid specified by the advertisers 214 may be provided by the ad server 206 to the learning model 204 where the target bid can be combined with a predicted conversion rate to produce a new or adjusted maximum CPC bid. The learning model 202, for example, can be used to compute the pCVR for a potential ad impression by collecting the number of clicks and conversions for each impression context feature of interest. As discussed above, a conversion rate defines a ratio of the number of conversions (e.g., # of sales generated by a given ad) to the number of clicks of the ad (i.e., # of visits to advertiser's web property from the ad). Thus, statistics can be calculated based on these numbers for use in predicting a conversion rate. Once the pCVR is determined, this parameter may be used with the target bid (e.g., multiplied by the target bid) to automatically adjust the advertiser's default click-based bid (e.g., maximum CPC bid) or compute a new click-based bid.

In some implementations, the learning model 202 is a machine learning system model that includes rules for mapping impression context features to conversion rate predictions. The rules may include, for example, a probability multiplier for each context feature. For example, a user from USA may be assigned a probability multiplier of 0.85, and an ad appearing on a particular news web site may be assigned a probability multiplier of 1.1. To predict a conversion rate, the default conversion rate can be aggregated with the probability multiplier for each relevant feature. Using the above example, for an ad having a default conversion rate of 0.2% that is shown on the particular news web site to a user from USA, the predicted conversion rate for the ad would be 0.187% (0.2%*1.1*0.85).

In some implementations, the pCVR can be used to compute or adjust an advertiser's click-based bid (e.g., Max CPC bid). For example, if the target CPA bid specified by an advertiser is $50 and the predicted conversion rate is 2%, then the maximum CPC bid can be automatically adjusted to $1 using the following formula:

MaxCPC(adjusted)=CPA_{BID}*pCVR [5]

If there is insufficient conversion data available to compute the pCVR, then the advertiser's specified default maximum CPC bid can be used as a metric, until sufficient conversion data has been gathered for the ad, at which time [5] can be used to automatically compute or adjust the maximum CPC bid. During the course of an ad campaign, the conversion data 208 (and optionally the learning model 202) can gradually change over time as more data is accumulated, while the impression context varies from auction to auction. These changes can result in the calculation of a new pCVR. The new pCVR can then be used in [5] “on-the-fly” so that the advertiser's default maximum CPC bid can be automatically and continuously computed or adjusted during an ad campaign or auction.

Based on [5], an expected CPM can be computed from a predicted clickthrough rate (pCTR), predicted conversion rate and target or maximum CPA bid. The expected CPM can be used to determine winning bids in an ad auction that ranks ad effectiveness using a suitable metric. For example, the performance of an ad can be measured by an estimated or effective cost-per-one thousand impressions (eCPM) of the ad. That is, the performance of an ad can be measured by the amount of revenue generated by presenting the ad to users one thousand times. The eCPM may be computed as a function of target CPA bid by replacing the term CPC_{BID} in [2] with a CPC bid defined in [5] to produce [6]:

eCPM_{CPA}=1000*pCTR*pCVR*CPA_{BID} [6]

Equation [6] defines that the publishers 216 may be credited for each conversion with the CPA bid specified by the advertisers 214. While equation [6] reduces the risks of the advertisers by specifying a CPA pricing model, this approach, however, is not optimized and favored by the publishers. Particularly, if the publishers are compensated only when conversions take place, the publishers are taking additional business risk as opposed to being compensated based on the number of clicks or impressions. Even if in the aggregate the net payment for the publishers in both models are the same (compensated by conversions or compensated by the number of clicks), the publishers would prefer to be compensated based on the number of clicks because of the low variability involved in the CPC or CPM pricing model. Accordingly, in some implementations, an estimated CPC bid (eCPC) as a function of target CPA bid may be determined based on predictive data (e.g., predicted conversion rate). The eCPC parameter can be used to develop a model that could be used to charge the advertisers on a CPA basis while crediting the publishers on a CPC basis.

To compute the eCPC for a CPC ad, it should be understood that the eCPC indicates an effective or estimated CPC bid. In an ideal market, the effective or estimated CPC bid should be the actual CPC bid specified by the advertisers. Given this relationship, the CPC bid term as defined in equation [2] may be treated as the eCPC:

eCPM_{CPC}=1000*pCTR*CPC_{BID} [7]

eCPM_{CPC}=1000*pCTR*eCPC [8]

Based on equation [6], the eCPC as defined in equation [8] can be determined as follows:

$$\begin{matrix}eCPC = \frac{{eCPM}_{CPC}}{1000 * pCTR} & [ 9 ] \\ eCPC = pCVR * {CPA}_{BID} & [ 10 ]\end{matrix}$$

Equation [10] allows publishers 216 to be compensated as a function of clicks while advertisers 214 are debited as a function of conversions. In short, a CPA ad can be estimated in real time to determine an equivalent CPC ad at serving time. When users click on an ad, the data associated with the click (and conversion data thereof) is received in real time. The publishers may be compensated by the number of clicks regardless of whether the users will convert, while the advertisers 214 can be charged as a function of conversions. This approach effectively creates incentives for publishers to participate in CPA advertising, because the publishers are not taking any additional risks or responsibilities beyond what is required in a CPC pricing model, which would result in additional CPA ads being served to users 218. This approach also significantly benefits the advertisers because the CPA advertising debits the advertisers only when a conversion is generated, and prevents charges against the advertisers on impressions or clicks that don't generate business.

With an ideal pCVR, payments expected to be credited to the publishers should be the same as the payments to be charged against the advertisers. However, in practical implementations where prediction conditions may change, the pCVR computed by the learning model 202 may not always be accurate. The conditions may include various factors, such as, for example, insufficient or inconsistent conversion data. In some instances, these factors may cause the pCVR to over-predict or under-predict a conversion rate. The inaccuracy can lead to a deviation between the revenues generated by the publishers (i.e., eCPC). For example, if the pCVR is over-predicted (e.g., from 0.1% to 0.2%), then a publisher may be credited at a higher cost per click than an actual cost for each displayed ad. As another example, if the pCVR is under-predicted (e.g., from 0.1% to 0.05%), the publisher may be compensated with a lower amount than that would have received under the designated pricing model.

To compensate for this pCVR deviation, in some implementations, a correction factor γ that is adaptive to the deviation or fluctuation of the predicted conversion rate may be computed and incorporated in [10]. The eCPC with the correction factor γ can generally be given by [11]:

$$eCPC = pCVR * {CPA}_{BID} * \frac{1}{γ} \qquad [ 11 ]$$

In some implementations, the correction factor γ in [11] may be computed (e.g., by the learning model 202) using an iterative process (e.g., a feedback loop) that compensates for the deviation error of the pCVR within a bidding period. The iterative process may employ historical performance data to obtain an accurate eCPC. The correction factor γ may be automatically adjusted in an adaptive way to mitigate changes or fluctuations of the predicted conversion rate so as to yield an accurate estimated CPC as a function of a CPA bid.

In some implementations, the iterations can be performed until a predetermined, dynamically determined, or other optimal value is reached for the correction factor. In certain implementations, a correction factor may be approximated (e.g., by the learning model 202) before iterations are performed, such as before a threshold number of iterations are performed. In other implementations, no further iteration is performed if the correction factor changes by less than a threshold amount after a particular iteration.

In some implementations, the correction factor γ may be updated multiple times over a single bidding period, or updated over multiple periods. This feedback strategy can equalize any pCVR deviation. For example, if it is determined that the pCVR in a given bidding period over-predicts the actual conversion rate, then the correction factor γ may be adjusted in a subsequent bidding period in a manner that would cancel out the discrepancies caused by the over-prediction (e.g., by incrementing or decrementing the correction factor γ to equal to the over-predicted CVR). Similarly, if it is determined that the pCVR in a given bidding period under-predicts the actual conversion rate, then the correction factor γ may be adjusted in a subsequent period in a manner that would cancel out the discrepancies caused by the under-prediction (e.g., by incrementing or decrementing the correction factor γ to equal to the under-predicted CVR).

In some implementations, the correction factor γ may generally be defined as:

$$γ = \frac{{α}_{( CPC , t )}}{{β}_{( CPA , t )}} \\ where \\ {α}_{( CPC , t )} = {\sum }_{t} Amount Paid To Publisher On A CPC Basis For CPA Ads \\ and \\ {β}_{( CPA , t )} = {\sum }_{t} Amount Received From Advertisers For Conversions On CPA Ads \qquad [ 12 ]$$

The parameter α_{(CPC, t)} defines an aggregate total paid to the publisher within a bidding period “t” and the parameter β_{(CPA, t)} defines an aggregate total charged against the advertiser within the bidding period “t.” The bidding period “t” may include data such as the time of the beginning and end of a bidding period, and may be defined as a function of a number of impressions or clicks. For example, a bidding period “t” may have a threshold of 10 conversions or 100 clicks). As another example, a bidding period “t” may have a threshold of 50 conversions or 5000 clicks. In some implementations, the value of the bidding period “t” may be adjusted to allow stability of the parameters α_{(CPC, t)} and β_{(CPA, t)}.

The parameters α_{(CPC, t)} and β_{(CPA, t)} may be based on the number of clicks, impressions and cost accrued over the bidding period “t.” These data, in some implementations, may be stored in the conversion data repository 208. In general, each bidding period “t” corresponds to a time interval between two bid updates. However, some intervals may not contain, for example, sufficient conversion data to reliably compute the correction factor γ (e.g., does not reach a predetermined threshold of 5000 impressions for each 500 clicks). Thus, in some implementations, multiple consecutive periods can be aggregated into a single bidding period. In other implementations, the correction factor γ can default to one, and can be adjusted or re-evaluated once the data threshold has been reached, noting that the correction factor γ, on average, can approach to one as the number of advertisers and publishers increases (e.g., as the number approaches one million or above), which means that the payout to the publishers is the same as the payment received from the advertisers. In some implementations, this payout may be the pre-revenue share, and may subject to any fee as agreed upon with the advertising management system 104.

After an initial pCVR is set, the correction factor γ can be periodically updated to compensate for potential pCVR deviation and to obtain an accurate eCPC for a next time period (e.g., an hour, a day, a week, etc.). The data used to determine the correct factor γ for a predefined period “t” may come from various sources. For example, when determining the parameters α_{(CPC, t)} and β_{(CPA, t)}, revenue per conversion, pricing model and bids, and clickthrough rate of an ad may be provided by the advertiser, while conversion rate information may be tracked by the advertising management system 104.

The bidding period “t” for which these parameters are measured can be empirically determined, or based on historical data. As an example, assuming that conversion data associated with a conversion is received and recorded (and learned by the learning model 202) within seven days, then the empirical bidding period may be set as seven days to allow the conversion data to be reflected in the parameters α_{(CPC, t)} and β_{(CPA, t)}. In some implementations, the bidding period “t” may be frequently or periodically adjusted to ensure that the difference between the parameters β_{(CPA, t)} and α_{(CPC, t)} are reduced. In another implementation, the bidding period “t” may be selected to ensure that an effective amount of data is available for determining the parameters α_{(CPC, t)} and β_{(CPA, t)}.

When the parameters β_{(CPA, t)} and α_{(CPC, t)} are mathematically equivalent (i.e., indicating that the amount of payment received from an advertiser based on a CPA pricing model is also the expected amount paid to a publisher on a CPC basis), then equation [12] would yield a correction factor γ of 1. In this instance, the eCPC would equal to the predicted conversion rate pCVR multiplied by the CPA bid specified by the advertiser, signifying that the amount the publisher is paid is consistent with the amount the advertiser is charged.

When the parameter α_{(CPC, t)} is greater than β_{(CPA, t)}, then the correction factor γ is greater than 1. In this scenario, the amount of payment paid to a publisher on a CPC basis is greater than the payment received from the advertiser based on a CPA pricing model. As a result, in a subsequent bidding period, the eCPC can be corrected by the term 1/γ so that the eCPC becomes smaller than a previous bidding period to compensate for the overpayment to the publisher.

When the parameter α_{(CPC, t)} is less than β_{(CPA, t)}, then the correction factor γ is less than 1. In this scenario, the payment received from the advertiser based on a CPA pricing model is greater than the amount of payment paid to a publisher on a CPC basis, which indicates that the publisher is paid less than that would have received under a traditional CPA model. As a result, in a subsequent bidding period, the eCPC can be corrected by the term 1/γ so that the eCPC becomes greater than a previous bidding period to compensate for the underpayment to the publisher.

While implementations above are described with respect to estimating a CPC as a function of a target CPA bid, other implementations also are applicable. For example, implementations with respect to estimating a CPM (e.g., crediting publishers on a CPM basis) as a function of a target CPC bid (e.g., charging advertisers on a CPC basis) also is contemplated. In these implementations, the target CPA bid may be replaced with a target CPC bid to compute an estimated CPM. As another example, the advertisers may be charged on CPA basis or CPC basis, while the publishers may be credited on a CPM basis. In this example, an advertiser may specify a maximum monetary value with the advertising management system as to how much the advertiser is willing to pay per user click or per conversion in response to an ad or ad group. An expected CPM can be computed as a function of this CPC or CPA value. The expected CPM can be used to determine a corresponding credit for compensating an associated publisher.

In general, the metric conversion system as described herein may ensure that over an empirically determined bidding period “t”, the difference of the amount paid to the publishers and charged against the advertisers will be less than a predetermined value. The system also ensures that the amount paid to the publishers and charged against the advertisers will not diverge more than a predetermined value over the bidding period “t”.

### Exemplary Processes

FIG. 3 is a flow diagram showing an example of a metric conversion process 300. The process 300 may be performed, for example, by the system 100 or 200, and for clarity of presentation, the description that follows uses these as the basis of examples for describing the process 300. However, another system, or combination of systems, may be used to perform the process 300.

As shown, the process 300 begins with obtaining a target CPA bid and conversion rate (302). The target CPA bid may be a maximum CPA bid specified by the advertisers. Alternatively, a recommended CPA bid may be provided by the advertising management system 104 and used as the target CPA bid. In some implementations, the target CPA bid may be an average CPA bid specified by the advertisers. In another implementation, the target CPA bid may be a minimum CPA bid specified by the advertisers.

The conversion rate may be determined based on the actual conversion rate. Alternatively, the conversion rate may be determined based on predictive data.

Based on the target CPA bid and the conversion rate, a CPC can be estimated (304). The publishers may be credited based on the estimated CPC (306), and the advertisers may be debited as specified by the target CPA bid previously specified (308).

Operations 302-308 may be performed in the order listed, in parallel (e.g., by the same or a different process, substantially or otherwise non-serially), or in reverse order to achieve the same result. In another implementation, operations 302-308 may be performed out of the order shown. For example, the advertiser may be debited based on the target CPA bid (308) followed by compensating the publisher based on the estimated CPC (306).

FIG. 4 is a flow diagram showing an example of a metric conversion process 400. The process 400 may be performed, for example, by the system 100 or 200, and for clarity of presentation, the description that follows uses these as the basis of examples for describing the process 400. However, another system, or combination of systems, may be used to perform the process 400.

Process 400 begins with receiving an advertiser input specifying a target bid for a given keyword or ad group (402). In some implementations, the target bid may include a maximum monetary value. The maximum monetary value may be based on the number of impressions, the number of clicks on an ad, or the number of conversions generated in response to an ad.

The process 400 then proceed with verifying the availability of conversion data (404). The conversion data may include, without limitation, data associated with the number of impressions, the number of clickthroughs and the number of clicks on an ad. The conversion data may be used to determine a correction factor.

In some implementations, the correction factor may be adaptive to the deviation or fluctuation of conversion data. If conversion data is not available or if conversion data is available but insufficient to determine a correction factor (“No” branch of operation 404), then a default correction factor may be used (406). For example, if there is insufficient conversion data available, a correction factor with a value of 1 may be used as default. During the course of an ad campaign, the conversion data can gradually change over time as more data is accumulated. In this case, the default correction factor can be adjusted or re-evaluated once the conversion data threshold has been reached. When sufficient conversion data become available, (“Yes” branch of operation 404), a correction factor may be determined. The correction factor may be computed based on the amount of payment credit to the publishers and the amount of payments received from the publishers.

In some implementations, the correction factor may be empirically computed using an iterative process. In these implementations, the iterative process may employ historical performance data to yield an accurate estimated CPC as a function of a CPA bid.

In other implementations, the correction factor may be approximated (e.g., by the learning model 202) before iterations are performed, such as before a threshold number of iterations are performed. In other implementations, no further iteration is performed if the correction factor changes by less than a threshold amount after a particular iteration.

In some implementations, the correction factor γ may be updated multiple times over a single bidding period, or updated over multiple periods.

The correction factor, in some implementations, may be defined in terms of a first parameter α_{(CPC, t)} that defines an aggregate total paid to the publisher within a bidding period “t” and a second parameter β_{(CPA, t)} that defines an aggregate total charged against the advertiser within a bidding period “t.” The bidding period “t” may include data such as the time of the beginning and end of a bidding period, and may be defined as a function of a number of impressions or clicks (e.g., a bidding period “t” has a threshold of one conversion per 100 clicks). The parameters α_{(CPC, t)} and β_{(CPA, t)} may be based on the number of clicks, impressions and cost accrued over the bidding period “t.” In general, each bidding period “t” corresponds to a time interval between two bid updates.

Process 400 then proceeds with predicting a conversion rate using the conversion data (410). In some implementations, the conversion data may include data associated with a default CPC bid and a target CPA bid specified by either the advertisers or the advertising management system. In these implementations, the conversion rate can be estimated by dividing a default CPC bid by a target CPA bid. Alternatively, the default maximum CPC bid can be used as default instead of predicting a conversion rate.

In another implementation, the conversion rate may be predicted by a machine learning model that collects historical data on previous conversion rates.

Process 400 ends with computing or adjusting the publisher's compensation using the correction factor, predicted conversion rate and target bid (412). In some implementations, after a conversion rate is predicted, the correction factor can be periodically updated to compensate for potential deviation in the predicted conversion rate so as to reduce any difference between the target bid (e.g., a target CPA bid) and the computed or adjusted compensation for the publisher (e.g., on CPC basis).

### Advertising Management System Architecture

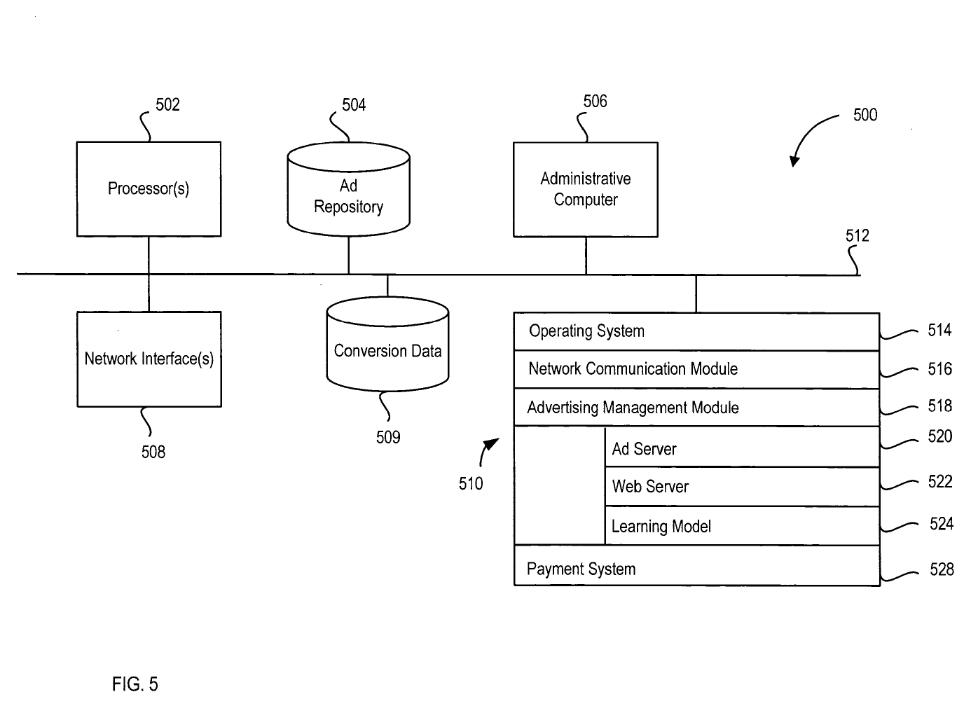

FIG. 5 is a block diagram of an exemplary architecture 500 for the ad management system 200 shown in FIG. 2, which can be configured to implement the processes 300 and 400 shown in FIGS. 3 and 4.

In some implementations, the architecture 500 includes one or more processors 502 (e.g., dual-core Intel® Xeon® Processors), one or more repositories 504, 509, one or more network interfaces 508, an optional administrative computer 506 and one or more computer-readable mediums 510 (e.g., RAM, ROM, SDRAM, hard disk, optical disk, flash memory, etc.). These components can exchange communications and data over one or more communication channels 512, which can include various known network devices (e.g., routers, hubs, gateways, buses) and software (e.g., middleware) for facilitating the transfer of data and control signals between devices.

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 510 further includes an operating system 514 (e.g., Linux server, Mac OS® server, Windows® NT server), a network communication module 516, an advertising management module 518 and a payment system 528.

The operating system 514 can be multi-user, multiprocessing, multitasking, multithreading, real-time and the like. The operating system 514 performs basic tasks, including but not limited to: recognizing input from and providing output to the administrator computer 506; keeping track of files and directories on computer-readable mediums 510 (e.g., memory or a storage device); controlling peripheral devices (e.g., repositories 504 and 509); and managing traffic on the one or more communication channels 512.

The network communications module 516 includes various components for establishing and maintaining network connections (e.g., software for implementing communication protocols, such as TCP/IP, HTTP, Ethernet, etc.).

The advertising management module 518 includes an ad server 520 and a web server 522. The advertising management module 518 further includes a learning model 524. The learning model 524 may perform and behave in a manner similar to learning model 202. The ad server 520 can be a server process or dedicated machine that is responsible for serving ads to publisher web properties and for tracking various information related to the ad placement (e.g., cookies, user URLs, page content, geographic information). The web server 522 (e.g., Apache web page server) serves web pages to advertisers and publishers and provides a means for advertisers and publishers to specify a target cost-per-action for use by the learning model 524 to dynamically compute or adjust an advertiser's click-based bid (e.g., Max CPC bid) or other performance metric.

The ad repository 504 can include various ads including, without limitation, image ads, text links, video and any other content that can be placed on a publisher web page and interacted with to drive users to advertiser properties.

The conversion data repository 509 can be used to store conversion data associated with an ad or ad group. The conversion data may be used by the learning model 524 to generate a predicted conversion rate for given ad or ad group.

The payment system 528 is responsible for implementing a payment process, whereby advertisers pay publishers. The payment process can be fully or partially automated, and can include human intervention at one or more points in the payment process.

The disclosed embodiments can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments of the invention have been described. Nevertheless, it will be understood that various modifications may be made without departing from the spirit and scope of the invention.

What is claimed is:

1. A method comprising:
obtaining input specifying a first metric value associated with an advertisement;
determining a predicted conversion rate for a potential impression of the advertisement;
estimating a second metric value based on the first metric value and the predicted conversion rate;
compensating based on the second metric value; and
debiting based on the first metric value.

2. The method of claim 1, wherein the first metric value and the second metric value are based on different bidding models.

3. The method of claim 2, wherein the bidding models include Cost-Per-Action, Cost-Per-Click and Cost-Per-Impression models.

4. The method of claim 2, wherein the first metric value is a value based on a Cost-Per-Action model, and the second metric value is based on a Cost-Per-Click model.

5. The method of claim 2, wherein the first metric value is a value based on one of Cost-Per-Click model or Cost-Per-Action model, and the second metric value is based on a Cost-Per-Impression model.

6. The method of claim 2, wherein determining a predicted conversion rate include mapping one or more impression context features to the predicted conversion rate using a learning model.

7. The method of claim 6, wherein the learning model is a machine learning system model that includes predetermined rules for mapping the one or more impression context features to the predicted conversion rate.

8. The method of claim 6, wherein the learning model is built using conversion data.

9. The method of claim 2, wherein estimating the second metric value includes multiplying the first metric value with the predicted conversion rate.

10. A method comprising:
receiving an advertiser input specifying a first metric value for a conversion event associated with an online advertisement;
determining a predicted conversion rate for a potential impression of the advertisement based on historical data;
determining a correction factor for the predicted conversion rate; and
automatically computing a second metric value using the first metric value, the predicted conversion rate and the correction factor.

11. The method of claim 10, wherein determining a correction factor includes:
monitoring a deviation error associated with the predicted conversion rate within a bidding period; and
automatically updating the correction factor in a subsequent bidding period.

12. The method of claim 11, wherein updating the correction factor includes incrementing or decrementing the correction factor to equalize the deviation error.

13. The method of claim 10, wherein the correction factor includes:
a first parameter indicative of an aggregate total paid to a publisher within a bidding period; and
a second parameter indicative of an aggregate total received from an advertiser within the bidding period.

14. The method of claim 13, wherein the first parameter and the second parameter are based on one of a number of clicks, impressions or cost accrued over the bidding period.

15. The method of claim 13, further comprising:
selecting the bidding period such that an optimum of data is available for determining the first parameter and the second parameter.

16. The method of claim 13, wherein computing a second metric value includes: correcting the second metric value by adjusting the correction factor in a subsequent bidding period if the first parameter is greater or less than the second parameter.

17. The method of claim 13, wherein adjusting the correction factor includes:
adjusting the bidding period such that a difference between the first parameter and the second parameter is optimally reduced.

18. The method of claim 10, wherein computing a second metric value includes multiplying the first metric value with the predicted conversion rate and the correction factor.

19. The method of claim 10, wherein the first metric is a value based on a Cost-Per-Action model, and the second metric value is based on a Cost-Per-Click model

20. The method of claim 10, wherein the first metric value is a value based on a one of Cost-Per-Click model or Cost-Per-Action model, and the second metric value is based on a Cost-Per-Impression model.

21. A system comprising:
a processor;
a computer-readable medium operatively coupled to the processor and including instructions, which, when executed by the processor, causes the processor to perform operations comprising:
obtaining input specifying a first metric value associated with an advertisement;
determining a predicted conversion rate for a potential impression of the advertisement;
estimating a second metric value based on the first metric value and the predicted conversion rate;
compensating based on the second metric value; and
debiting based on the first metric value.

22. A system comprising:
a processor;
a computer-readable medium operatively coupled to the processor and including instructions, which, when executed by the processor, causes the processor to perform operations comprising:
receiving an advertiser input specifying a first metric value for a conversion event associated with an online advertisement;
determining a predicted conversion rate for a potential impression of the advertisement based on historical data;
determining a correction factor for the predicted conversion rate; and
automatically computing a second metric value using the first metric value, the predicted conversion rate and the correction factor.

23. A computer-readable medium having instructions stored thereon, which, when executed by a processor, causes the processor to perform operations comprising:
obtaining input specifying a first metric value associated with an advertisement;
determining a predicted conversion rate for a potential impression of the advertisement;
estimating a second metric value based on the first metric value and the predicted conversion rate;
compensating based on the second metric value; and
debiting based on the first metric value.

24. A computer-readable medium having instructions stored thereon, which, when executed by a processor, causes the processor to perform operations comprising:
a processor;
a computer-readable medium operatively coupled to the processor and including instructions, which, when executed by the processor, causes the processor to perform operations comprising:
receiving an advertiser input specifying a first metric value for a conversion event associated with an online advertisement;
determining a predicted conversion rate for a potential impression of the advertisement based on historical data;
determining a correction factor for the predicted conversion rate; and
automatically computing a second metric value using the first metric value, the predicted conversion rate and the correction factor.

25. A system comprising:
means for obtaining input specifying a first metric value associated with an advertisement;
means for determining a predicted conversion rate for a potential impression of the advertisement;
means for estimating a second metric value based on the first metric value and the predicted conversion rate;
means for compensating based on the second metric value; and
means for debiting based on the first metric value.

26. A system comprising:
means for receiving an advertiser input specifying a first metric value for a conversion event associated with an online advertisement;
means for determining a predicted conversion rate for a potential impression of the advertisement based on historical data;
means for determining a correction factor for the predicted conversion rate; and
means for automatically computing a second metric value using the first metric value, the predicted conversion rate and the correction factor.
